(19) United States
(12) Patent Application Publication
(10) Pub. No.: US 2026/0104959 A1
(43) Pub. Date: Apr. 16, 2026

(54) SYSTEM AND METHOD FOR PROVIDING A SAFE, SECURE, PROGRAMMABLE, AND IoT-CAPABLE INTEGRATED POWER MANAGEMENT SOLUTION

(71) Applicant: L&T Semiconductor Technologies Limited, Mumbai (IN)

(72) Inventors: Sandeep Kumar, Austin, TX (US); Peter Eyabi, Escondido, CA (US)

(73) Assignee: L&T Semiconductor Technologies Limited, Mumbai (IN)

(21) Appl. No.: 19/357,486

(22) Filed: Oct. 14, 2025

Related U.S. Application Data
(60) Provisional application No. 63/706,800, filed on Oct. 14, 2024.

(51) Int. Cl. G06F 11/07; G06F 8/65; G06F 9/4401

(52) U.S. Cl. CPC G06F 11/0793; G06F 8/65; G06F 9/4403; G06F 11/0721; G06F 11/0784

(57) ABSTRACT

A method for safe, secure, programmable and IoT-capable integrated power management is provided. The method includes (i) configuring, a plurality of PMIC chiplets, a wireless connectivity module, and compute chiplet, where each PMIC chiplet and the compute chiplet comprises a set of twin dies (i.e. a first die and a second die). The compute chiplet comprises a set of twin dies (i.e. a first compute die and a second compute die), supporting wired and wireless connections to an electronic control unit (ECU) and a wireless connection to the cloud, through which data, events, messages are exchanged via both connections.

### BACKGROUND

### Technical Field

The embodiments herein generally relate to power management systems, and more particularly, to a system and a method for an integrated programmable power management solution that is safe, secure and supports wireless connectivity to everything.

### Description of Related Art

A power management solution that configures and distributes electrical power to electronic devices or a system of integrated circuits. The power management solution is composed of multi-die power management integrated circuits (PMICs), a microprocessor die and a wireless connectivity die, all integrated into a single package, or substrate or a chip to efficiently distribute electrical power to electronic devices. Existing PMIC technology does not allow for any performance modifications post factory configuration, making it impossible to update/optimize performance, without installing a new component. Additionally, there is no provision for PMIC firmware updates post-development, further restricting adaptability.

Existing systems for power management are constrained by several limitations, including fixed maximum PMIC voltage regulator settings, which lack flexibility, and result in inefficiency and suboptimal performance due to an inability to adapt to changes in power draw. The rigidity of the existing systems can lead to excessive power consumption, thermal issues, and increased component stress, ultimately reducing system reliability if there is any increase in power drawn. Additionally, the inability to modify current settings dynamically restricts the implementation of advanced power management strategies, compromising both energy efficiency and overall performance. Furthermore, unused PMIC regulators are typically disabled during development, limiting the potential for future optimization. This lack of flexibility means that faults in either an electronic control unit (ECU) or the PMIC result in system shutdowns, significantly impacting vehicle availability.

In current power management systems, the PMICs are not designed as Internet of Things (IoT) capable devices, and their safety concepts are fixed since the firmware image cannot be modified post-integration. The system of integrated circuits being powered by the PMIC, for example, a vehicle Electronic Control Unit (ECU), supports a control and safety architecture that assumes the presence of a microprocessor/embedded controller as an external controller and safety monitor, respectively, since the PMICs do not support compute capabilities and are not smart devices. These external dependencies prevent independent startup, reset and fault recovery of ECUs powered by the PMICs, adding another layer of dependency on an external monitor or control system.

Accordingly, there remains a need for a more efficient system and method for mitigating and/or overcoming drawbacks associated with the fixed architecture of current power management systems.

### SUMMARY

The present disclosure relates to a system and method of safe, secure, programmable, and IoT-capable integrated power management solution, capable of powering external ECUs. The system includes multiple Power Management Integrated Circuit (PMIC) chiplets, compute chiplets, and a wireless/wired connectivity chiplet. In the off state, the compute chiplets are powered by an external power source. After boot is completed, the compute chiplets trigger the start of the power-On sequences of the PMIC and wireless connectivity chiplets. Power on initiates boot and after boot completion, the compute chiplet establishes data connections with the wireless and PMIC chiplets, validates their authenticity, and takes them out of reset into the mission state. In mission state, the connectivity chiplet securely retrieves, authenticates, and downloads firmware to the PMIC chiplets, and SW to the compute chiplets. Since, the compute chiplet is programmable and relies on an external power source, it functions as the system safety and control manager, i.e. managing system state transitions (On, Off, Sleep, Reset, etc.) of PMIC and connectivity chiplets. In addition, the compute chiplets can control, manage faults and system states of any ECU, external to the system. Hence, eliminating the need for an external processor as system safety monitor and controller.

In this aspect, the present disclosure relates to a system and method of safe, secure, programmable, and IoT-capable integrated power management solution. The system includes a plurality of Power Management Integrated Circuit (PMIC) chiplets, that are connected to a set of compute chiplets. Each of the plurality of PMIC chiplets is composed of twin chiplets. The system also includes twin compute chiplets with embedded memory and programmable logic. In addition, the system also has a wireless/wired connectivity chiplet that is connected to the compute chiplets.

In an embodiment, upon detecting a faulty chiplet, the compute chiplets are capable of triggering a failure recovery sequence or safe state transition of the faulty chiplet, without external intervention.

In an embodiment, each of the plurality of PMIC chiplets includes a first die designed for power management and a second die designed as a safety manager. Hence, each PMIC cluster has a safety manager to monitor and manage faults within its cluster.

In an embodiment, the compute chiplet includes a first compute die that is programmable and functions as the system processor, and a second compute die designed as a safety manager, capable of monitoring and managing not only compute chiplet faults, but also functions as the overall system controller and safety manager.

In an embodiment, the first compute die schedules and manages power scaling and current limit policies, of the entire system, as needed to modulate system performance.

In an embodiment, the compute chiplets are configured to receive and manage events and data from system components (PMIC and connectivity chiplets), and ECU's external to the system, through the hardwired connections.

In an embodiment, the events are signals related to operational health, detected faults, subsystem states, etc., of each of the plurality of PMIC and connectivity chiplets and any ECU external to the system.

In an embodiment, the connectivity chiplet is designed to receive and authenticate software or/and firmware from the cloud, via the over-the-air (OTA) updates.

Another embodiment of the present disclosure pertains to a method of safe, secure, programmable, and IoT-capable integrated power management solution to execute fault recovery or safe state transition of ECUs external to the system, or itself, in which case the system and method of safe, secure, programmable, and IoT-capable integrated power management solution experiences a fault recovery or safe state transition.

### BRIEF DESCRIPTION OF THE DRAWINGS

The embodiments herein will be better understood from the following detailed description with reference to the drawings, in which:

FIG. 1 is a block diagram that illustrates a system that is a safe, secure, programmable and IoT-capable integrated power management solution according to some embodiments herein.

FIG. 2 illustrates a block diagram of the architecture of a safe, secure, programmable and IoT-capable integrated power management system of FIG. 1 according to some embodiments herein.

FIGS. 3A and 3B are flow diagrams that illustrate a method for providing safe, secure, programmable and IoT-capable integrated power management according to some embodiments herein; and

FIG. 4 is a representative hardware environment for practicing the embodiments herein with respect to FIG. 1 through 3B.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

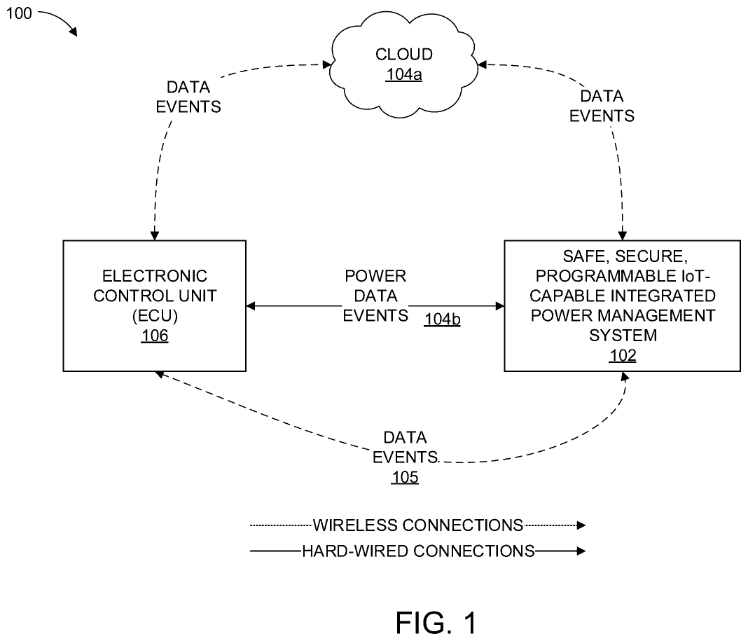

In view of the foregoing, the need for a system and method for power management using programmable and IOT-capable power management integrated circuits (PMICs). Referring now to the drawings, and more particularly to FIGS. 1 through 4, where similar reference characters denote corresponding features in a consistent manner throughout the figures, there are shown preferred embodiments.

A “power Management Integrated Circuit (PMIC)” refers to a specialized electronic component designed to manage and distribute power to a system of embedded integrated circuits. PMICs are commonly used in devices like smartphones, tablets, wearables, and other embedded systems. The PMICs integrate various functions such as voltage regulation, power sequencing, safety monitoring, and current limiting.

An “Electronic Control Unit (ECU)” refers to an embedded system in vehicles that controls various electrical functions. ECUs manage key operations like engine performance, transmission, braking, and body controls (e.g., lights and locks). Modern vehicles can have numerous ECUs working together to optimize efficiency, safety, and performance.

An “IoT-capable Power Management Integrated Circuit (PMIC)” refers to a specialized chip capable of connecting to the cloud and download/upload data from/to the cloud, respectively. The PMICs are optimized for average and peak power supply as determined during factory configuration. By integrating a wireless unit, it ensures the power management solution as a system can connect wirelessly to anything, including the cloud, and exchange data.

FIG. 1 illustrates a system 100 that provides a safe, secure, programmable and IoT-capable integrated power management solution according to some embodiments herein. The system 100 includes a safe, secure, programmable and IoT-capable integrated power management system 102, and an electronic control unit (ECU) 106. The safe, secure, programmable and IoT-capable integrated power management system 102 communicates with the ECU 106, through an onboard wired/wireless connectivity module 208, that transmits data via the cloud 104a or a cable (e.g. for a wired connection) 104b. In some embodiments, the communication medium 104a is wired. In some embodiments, the communication medium 104b is wireless. The data transfer to/from the safe, secure, programmable and IoT-capable integrated power management solution, referred to as the system 102 is enabled by the wired/wireless connectivity module/chiplet 208, comprising at least one Wi-Fi, Bluetooth, 5G/4G, near field wireless connectivity modules, etc. In some embodiments, the wireless/wired connectivity module 208 is a combination of a wired and a wireless module. In some embodiments, the communication media 104a is the Internet or cloud. The wireless connectivity module 208 is equipped with wireless data transfer security support (e.g. levels of message/data encryption, authentication, etc.) with Wireless Protected Access 3 (WPA3) and ISO21434 compliance. The wireless connectivity module 208 supports secure, external, high-speed, low-latency connectivity with external devices such as ECU 106 and enables safe and secure data download and upload from and to remote servers. The wireless connectivity module 208 enables data download of Software (SW) or firmware (FW) via over-the-air (OTA) updates. Hence, this enables the download of SW/FW to the safe, secure, programmable and IoT-capable integrated power management system 102. The safe, secure, programmable and IoT-capable integrated power management system 102, without limitation, may be a component, a mobile phone, a Personal Digital Assistant (PDA), a tablet, a desktop computer, a laptop, an airplane, a space vehicle or a sea/water vessel or a land based mobile or stationary unit. The safe, secure, programmable and IoT-capable integrated power management system 102 includes N number of power management integrated circuit (PMIC) chiplets 202A-D, where N is a multiple of 2 (e.g., 2, 4, 8, 16, etc.), and a compute chiplet 206/a microprocessor and a wireless connectivity chiplet/unit/module 208.

Each PMIC 202A-D is composed of twin chiplets or dies, namely a first die and second die. This twin arrangement provides freedom from interference, with respect to single point faults, originating from a die. The first die (Die 1) 204A-D may be a power management die composed of an analog and digital power infrastructure. The second die (Die 2) 205A-D is a safety manager. The second die 205A-D safely monitors the analog and digital infrastructure of the first die, including its input/output and internal signals. The compute chiplet 206 may be a microcontroller, a microprocessor, a system on-chip (SoC), an embedded controller, etc. The compute chiplet includes a first programmable compute die (compute die 1) 206A and a second compute die (compute die 2) 206B. The first compute die 206A may be an algorithm or data handling die for managing the system programming, controls and computations, e.g. a processor. The second compute die 206B safely monitors the SW and HW of the compute dies as well as its inputs, outputs and internal signals.

The safe, secure, programmable and IoT-capable integrated power management system 102 supplies electrical power to an external load/device, such as an electronic control unit 106, and can exchanges data and events with 106 through its secured interfaces. Such data may include, but not limited to binary data, configuration data, measurements, etc. Also, the events include, but not limited to, health, fault, and diagnostics status/messages, etc. The compute chiplet may trigger functional activation/deactivation of the PMIC, connectivity chiplets, or any external ECUs, like 106, using hardware signals. The compute chiplet 206 triggers and manages the Power ON/OFF/RESET, etc. sequences of the PMIC chiplets 202A-D, without any external dependencies, since it is powered by an external power source, like a capacitor, battery, etc. Fault management of the PMICs can be executed by the compute chiplets, if a critical fault originates from the first die 204A-D or the second die 205A-D of PMIC chiplets 202A-D. The compute chiplets 206 could trigger a fault recovery sequence or a safe state transition of the faulty die, without impacting the functional operation of the non-faulty die of the PMIC chiplet 202A-D. For example, if a critical fault originates from the first die 204A-D of the PMIC chiplets 202A-D, the compute chiplets 206 receives the event, and triggers a fault recovery or safe state transition of faulty die, with no impact to the functional operation of healthy PMIC chiplets in the PMIC cluster/arrangement of the safe, secure, programmable and IoT-capable integrated power management system 102, as each PMIC chiplet operates independently as a safe power management unit.

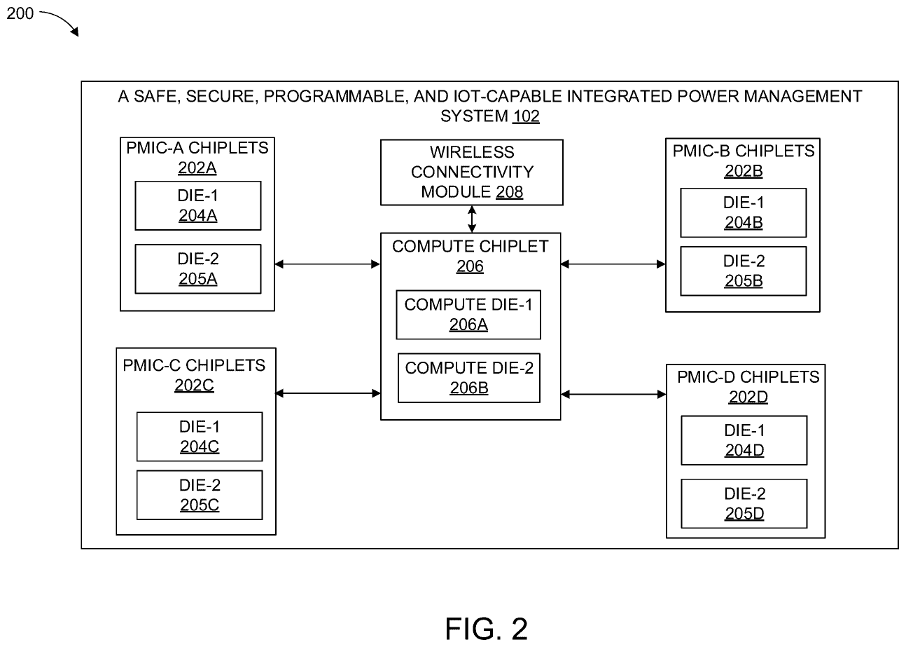

FIG. 2 illustrates a block diagram of the architecture of a safe, secure, programmable and IoT-capable integrated power management system of FIG. 1 according to some embodiments herein. The safe, secure, programmable and IoT-capable integrated power management system 102 includes N number of identical PMIC chiplets 202A-D and a compute chiplet 206. Here, the N number of identical PMIC chiplets includes a PMIC-A chiplet 202A, a PMIC-B chiplet 202B, a PMIC-C chiplet 202C, and a PMIC-D chiplet 202D. Each PMIC chiplet includes a first die 204A-D and a second die 205A-D. The compute chiplet 206 includes a first compute die 206A and a second compute die 206B. The first die 204A-D of each PMIC chiplet may be a power management subsystem. The first dies 204A-D may include power regulators, registers, ADCs, communication interfaces, clocks, dedicated power input resources, and infrastructure for managing input and output power. The regulators of the first die 204A-D may supply power to external loads, including the electronic control units (ECUs) 106. The second dies 205A-D are safety managers, also termed Safety Island subsystems with regulators capable of supplying internal and external loads. The safety island subsystems present in the PMIC chiplet 202A-D and the compute chiplet 206 manage and monitor faults within itself and its twin die (i.e. the first die and second die) as well as capable of executing similar functions as the first die. For example, the second dies 205A-D may include safety mechanisms, communication interfaces, dedicated power input resources, and infrastructure for fault handling and management, of the PMIC chiplet. The second dies 205A-D may be designed to ensure the safe operation of PMIC chiplet during startup and normal operation. In some embodiments, the second die 205A-D incorporates specialized safety features to monitor and respond to errors/faults and maintains communication channels for data exchange. The second dies 205A-D have dedicated power sources, independent of the first dies, 204A-D, to ensure continuous and independent operation. Additionally, the second die 205A-D may include infrastructure to handle and manage faults effectively, helping to protect the overall safe, secure, programmable and IoT-capable integrated power management system 102 and maintain the functionality of the safe, secure, programmable and IoT-capable integrated power management system 102.

The first compute die 206A of the compute chiplet 206 employs algorithms to manage data associated with the safe, secure, programmable and IoT-capable integrated power management system 102. Such algorithms include services, applications, power management, etc. The first compute die 206A includes a CPU, ADC, ROM, RAM, EEPROM, PLL, and various peripheral interfaces. In some embodiments, the first compute die 206A of the compute chiplet 206 manages power-on control for the N number of all PMIC chiplets 202A-D of the safe, secure, programmable and IoT-capable integrated power management system 102, as well as onboard computation, data storage, and data transfer. In compliance with ISO26262 safety standards, the first compute die 206A of the compute chiplet 206 is responsible for programming and configuring the PMIC chiplets 202A-D. The second compute die 206B of the compute chiplets 206 incorporates hardware and software safety mechanisms and robust fault handling infrastructure but may also embody similar functions hosted by its twin die. The safety mechanisms are designed to monitor, prevent, detect, and respond to potential faults or hazards, ensuring the safe operation of the safe, secure, programmable and IoT-capable integrated power management system 102 under various conditions. The compute chiplets 206 includes fault handling function that supports a framework for detecting faults, diagnosing the causes, and implementing recovery actions, thereby mitigating their impact and maintaining reliable, safe operation even when issues arise.

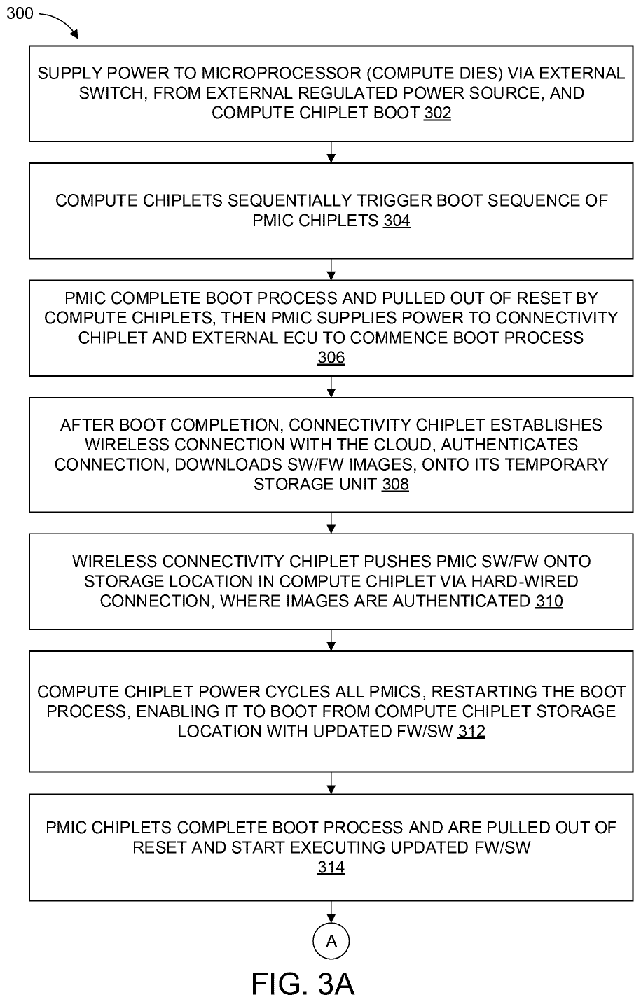

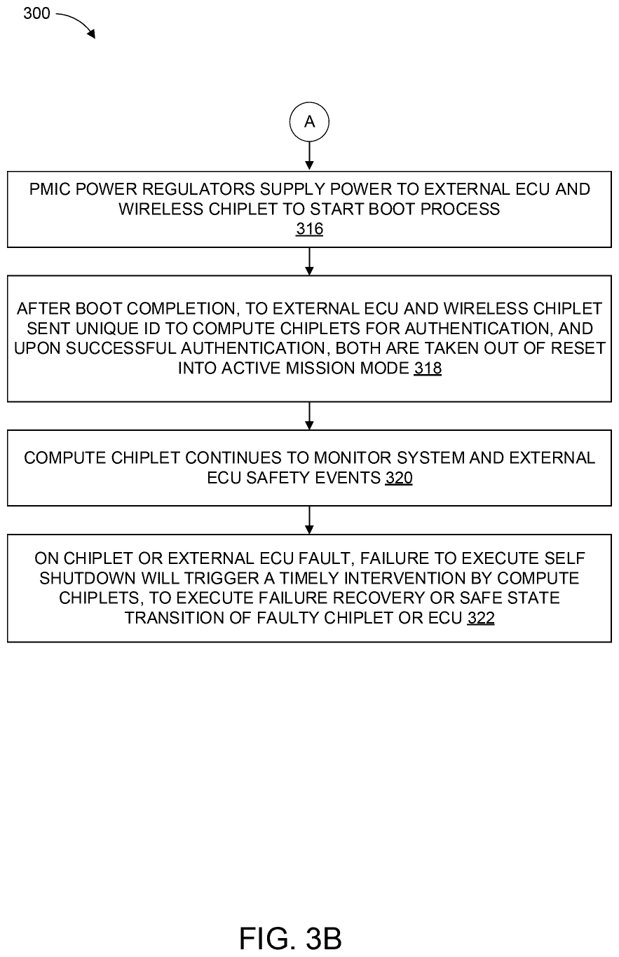

FIGS. 3A and 3B are flow diagrams that illustrate a method 300 for providing a safe, secure, programmable and IoT-capable integrated power management according to some embodiments herein. At step 302, the compute chiplets are powered by an external source and complete the boot process. At step 304, the compute chiplets trigger boot or power on sequence of PMICs chiplets 202A-D. At step 306, PMICs complete the boot process and are pulled out of reset. The regulators then power external ECU and wireless chiplet.

At step 308, the wireless connectivity chiplet/module 208 completes the boot process, establishes wireless connection with the cloud, authenticates the connection, then downloads SW/FW wirelessly onto its temporary storage. At step 310, the connectivity chiplet pushes SW/FW onto storage locations in the compute chiplets 206 via hard-wired connection, where the SW/FW images are authenticated. At step 312, the compute chiplet 206 power cycles all PMICs 202A-D, restarting the boot process, from storage locations in compute chiplet security module, authenticates PMIC FW/SW before allowing PMIC boot process to continue. FW is copied over to the PMICs 202A-D via hard-wired connection 104b.

At step 314, the PMICs 202A-D complete the boot process, and are pulled out of reset by the compute chiplets 206, assuming all safety checks are successful and enter mission mode with updated FW/SW. At step 316, PMICs 202A-D power regulators of the plurality of PMIC chiplets to supply power to the connectivity chiplet, and the external ECU 106, starting their boot processes. At step 318, the external ECU 106 and the wireless connectivity chiplet complete the boot process, and send unique IDs to the compute chiplets 206, for authentication, after which they are taken out of reset. At step 320, the compute chiplet 206 continues to monitor safety events from external ECU, PMICs and connectivity chiplets. At step 322, on detection of chiplet or external ECU fault, it leads to a start of fault recovery sequence or safe state transition of the faulty chiplet, triggered by the compute chiplets 206. All event messages and onboard data are eventually transmitted to the cloud 104a via wireless connectivity module 208.

The safe, secure, programmable and IoT-capable integrated power management system 102 uses die-to-die interconnect, as a means of data and message exchange among its dies. The safe, secure, programmable and IoT-capable integrated power management system 102 is smart, since it executes on-chip computation and is programmable. The safe, secure, programmable and IoT-capable integrated power management system is configurable, since FW/SW can be updated via over-the-air (OTA) updates. The safe, secure, programmable and IoT-capable integrated power management system 102 supports power scalability since the compute chiplet can enable/disable regulators in PMIC chiplets in real time. Additionally, the system's scalability and flexibility make it suitable for a wide range of applications, contributing to a more efficient and cost-effective power management solution.

Also, through its wireless connectivity, the safe, secure, programmable and IoT-capable integrated power management system supports remote diagnostics, meaning performance issues can instantly be diagnosed via the cloud by reading all its events/data logs wirelessly. Also, through its wireless connectivity, the safe, secure, programmable and IoT-capable integrated power management system supports remote diagnostics, meaning performance issues can instantly be diagnosed via the cloud by reading all its events/data logs wirelessly.

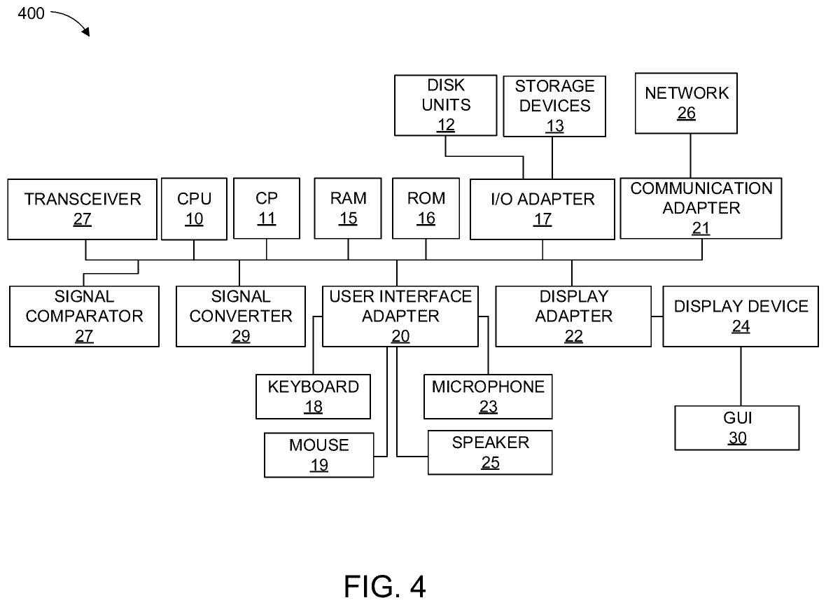

A representative hardware environment for practicing the embodiments herein is depicted in FIG. 4, with reference to FIGS. 1 through 3. This schematic drawing illustrates a hardware configuration of a computer /stem/ computing device in accordance with the embodiments herein. The system includes at least one processing device, CPU 10 that may be interconnected via system bus 14 to various devices such as a random-access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown). Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

We claim:

1. A safe, secure, programmable, and IoT-capable integrated power management system comprising:
a plurality of Power Management Integrated Circuit (PMIC) chiplets, wherein each of the plurality of PMIC chiplets comprises a power management die and a safety management die;
compute chiplets comprising a compute processor chiplet and a safety management chiplet, the compute chiplet comprising embedded memory and a programmable logic, wherein the memory comprises instructions, which when executed by the compute processor chiplet, is capable of executing system control of external Electronic Control Units (ECUs), the plurality of PMICs, and connectivity chiplets; and
a wireless connectivity chiplet to fetch firmware/software (FW/SW) updates for each of the plurality of PMIC chiplets and itself, via secured network connections, from the cloud, upon successful authentication of a firmware source, and store the firmware in a storage associated with the wireless connectivity chiplet, and wherein the wireless connectivity chiplet is configured to push the stored firmware onto a storage location associated with the compute chiplets via a hardwired connection,
wherein the stored firmware, from the storage location associated with the compute chiplets, is pushed to the corresponding PMIC chiplets via the hardwired connection, wherein the firmware of each of the plurality of PMIC chiplets is authenticated prior to initiating a boot process of each of the plurality of PMIC chiplets,
wherein the plurality of PMIC chiplets are configured to execute a safety self-test and complete the boot process, if all safety checks are successful, send power-ready events and unique identification data to the compute chiplets via the hard-wired connection, for authentication,
upon successful authentication, PMIC regulators of the plurality of PMIC chiplets are allowed to enable power to any external ECU, allowing the ECU to start and complete the boot process, wherein the ECU, upon completing the boot process, send unique identification data of the ECU to the compute chiplets for authentication, prior to being pulled out from reset to enter a mission mode,
wherein the compute chiplets are configured to monitor system events and detect faults originating from any of the plurality of PMIC chiplets, the connectivity chiplet, the compute chiplets, or the external ECUs, and to initiate a system recovery or a transition to a safe state in response to the detected fault, and
wherein the compute chiplets are configured to perform wireless transmission of fault log data to the cloud.

2. The system of claim 1, wherein each of the plurality of PMIC chiplets comprises a first die configured for power management and a second die configured as a safety island to monitor the first die, wherein each of the plurality of PMIC chiplets operates independently as a safe power manager.

3. The system of claim 1, wherein the compute chiplets comprise a first compute die designed to execute programming, control, and computation of the system, and a second compute die configured as a safety island/manager, for fault monitoring and management of system and external faults.

4. The system of claim 1, wherein the compute chiplets are designed to trigger and manage system states: power ON, power OFF, and power RESET.

5. The system of claim 3, wherein the first compute die manages system states, power scalability, and current limit policies for optimizing system performance.

6. The system of claim 1, wherein the compute chiplets are designed to receive the safety events from the external ECUs through the hardwired connections.

7. The system of claim 1, wherein the safety events are data and signals related to operational health and safety status of each of the plurality of PMIC, connectivity chiplets, and the external ECUs.

8. The system of claim 1, wherein the compute chiplets are configured to receive and authenticate firmware/software updates via over-the-air (OTA) network connection.

9. The system of claim 8, wherein the updated software/firmware targets the plurality of PMIC chiplets, the compute chiplets, or the external ECU.

10. A method for safe, secure, programmable, and IoT-enabled power management in an integrated multi-chiplet system, the method comprising:
downloading, by a wireless connectivity chiplet of a system, firmware or software updates from a cloud via a secured network connection;
authenticating, by the wireless connectivity chiplet, a source of the downloaded firmware;
storing, by the wireless connectivity chiplet, the authenticated firmware in a storage associated with the wireless connectivity chiplet;
transferring, by the wireless connectivity chiplet, the stored firmware to a storage location associated with compute chiplets via a hardwired connection.

11. The method of claim 10, further comprising:
pushing, by the compute chiplets, the stored firmware from the storage location to each of a plurality of Power Management Integrated Circuit (PMIC) chiplets via the hardwired connection.

12. The method of claim 11, further comprising:
authenticating, by each PMIC chiplet, the corresponding firmware prior to initiating a boot process;
executing, by each PMIC chiplet, a safety self-test during the boot process;
completing, by each PMIC chiplet, the boot process when all safety checks are successful; and
sending, by each PMIC chiplet, a power-ready event and unique identification data to the compute chiplets via the hardwired connection.

13. The method of claim 12, further comprising:
authenticating, by the compute chiplets, the unique identification data of each PMIC chiplet,
wherein upon successful authentication, enabling, by PMIC regulators of the authenticated PMIC chiplets, power delivery to one or more external ECUs, allowing the ECU to start and complete the boot process, wherein the ECU, upon completing the boot process, send unique identification data of the ECU to the compute chiplets for authentication, prior to being pulled out from reset to enter a mission mode.

14. The method of claim 13, further comprising:
monitoring, by the compute chiplets, system events originating from the plurality of PMIC chiplets, the compute chiplets, the wireless connectivity chiplet, and the one or more external ECUs;
detecting, by the compute chiplets, a fault from any system component;
executing, by the compute chiplets, a system recovery procedure or a safe state transition in response to the detected fault; and
transmitting, wirelessly to the cloud, fault log data associated with the detected fault.
